(19) United States
(12) Patent Application Publication
(10) Pub. No.: US 2013/0088680 A1
(43) Pub. Date: Apr. 11, 2013

(54) LIQUID CRYSTAL DISPLAY PANEL AND LIQUID CRYSAL DISPLAY DEVICE

(71) Applicants: Takehisa Sakurai, Osaka-shi (JP); Mitsuhiro Murata, Osaka-shi (JP); Shoichi Ishihara, Osaka-shi (JP); Shuichi Kozaki, Osaka-shi (JP); Yosuke Iwata, Osaka-shi (JP)

(72) Inventors: Takehisa Sakurai, Osaka-shi (JP); Mitsuhiro Murata, Osaka-shi (JP); Shoichi Ishihara, Osaka-shi (JP); Shuichi Kozaki, Osaka-shi (JP); Yosuke Iwata, Osaka-shi (JP)

(21) Appl. No.: 13/522,378

(22) PCT Filed: Oct. 21, 2010
(86) PCT No.: PCT/JP2010/068617

§ 371 Date: Dec. 17, 2012

(30) Foreign Application Priority Data
Jan. 15, 2010 (JP) 2010-006688

(51) Int. Cl. G02F 1/1343

(52) U.S. Cl. CPC G02F 1/134309
USPC 349/141

(57) ABSTRACT

The present invention provides a liquid crystal display panel and a liquid crystal display device which have a high response speed. The present invention relates to a liquid crystal display panel including a first substrate and a second substrate disposed to face each other, and a liquid crystal layer sandwiched between the first substrate and the second substrate, wherein the liquid crystal layer includes a liquid crystal molecule having positive dielectric anisotropy; the liquid crystal molecule is aligned perpendicularly to a surface of the first substrate when no voltage is applied; the first substrate includes a signal line, a scanning line, a first electrode to which an image signal is provided through the signal line, and a second electrode; the first electrode includes a first comb-tooth portion; the second electrode includes a second comb-tooth portion; the first comb-tooth portion and the second comb-tooth portion are disposed in the same layer to planarly face each other in a pixel; the second substrate includes a third electrode and a dielectric layer disposed on the liquid crystal layer side of the third electrode, the third electrode covering at least a display region; and the slowest rise response speed is not more than twice a rise response speed upon application of a maximum gradation voltage to the display panel to which no voltage has been applied.

### TECHNICAL FIELD

The present invention relates to a liquid crystal display panel and a liquid crystal display device. More specifically, the present invention relates to a liquid crystal display panel and liquid crystal display device that adopt an oblique electric field system.

### BACKGROUND ART

Active matrix liquid crystal display devices that use an active element typified by a thin film transistor (TFT) are widely used as display devices because of the advantageous features such as thin profile, light weight, and high image quality comparable to a cathode-ray tube. The display systems of such active matrix liquid crystal display devices are broadly classified into the following two kinds of display systems.

The first kind is a vertical electric field system. According to this system, a liquid crystal layer is driven by an electric field in a direction approximately perpendicular to a substrate surface, and light that is incident on the liquid crystal layer is modulated and displayed. Conventionally known liquid crystal modes of vertical electric field system include TN (twisted nematic) mode and MVA (multi-domain vertical alignment) mode.

The other kind is a transverse electric field system. According to this system, a liquid crystal layer is driven by an electric field in a direction approximately parallel to a substrate surface. Conventionally known liquid crystal modes of transverse electric field system include IPS (in-plane switching) mode.

Moreover, as a display system other than the above systems, an oblique electric field system is known (see, for example, Patent Literatures 1 and 2, and Non-Patent Literatures 1 and 2). According to this system, a liquid crystal layer is driven by an electric field in a direction oblique to a substrate surface. Specifically, for example, a liquid crystal display device is known which includes a pair of substrates, a liquid crystal enclosed between the pair of substrates, a plurality of stripe electrodes per pixel formed on one of the substrates, and a transparent electrode formed on the other substrate to cover substantially the whole of the substrate. In the liquid crystal device, the plurality of stripe electrodes include first stripe electrodes and second stripe electrodes, the first electrodes and the second electrode being in parallel to one another, the first stripe electrodes receiving a first voltage, the second stripe electrodes receiving a second voltage that is different from the first voltage.

### CITATION LIST

### Patent Literature

[Patent Literature 1] JP-A 2000-305100

[Patent Literature 2] US Patent Application Publication No. 2009/0091587

### Non-Patent Literature

[Non-Patent Literature 1] H. Yoshida, et al., “Fast-Switching LCD with Multi-Domain Vertical Alignment Driven by Oblique Electric Field”, SID 00 Digest, 2000, No. 23.1, p. 334-337

[Non-Patent Literature 2] In Yong Cho, et al., “New Vertical Alignment Liquid Crystal Device with Fast Response Time and Small Color Shift”, IDRC 08, 2008, No. 11.2, p. 246-248

### SUMMARY OF INVENTION

### Technical Problem

However, liquid crystal display panels of vertical or transverse electric field system such as IPS mode, TN mode, and MVA mode need to be further improved in terms of the response speed. Moreover, conventional liquid crystal display devices of an oblique electric field system have a low response speed in some cases.

The present invention has been made in view of the above circumstances and an object of the present invention is to provide a liquid crystal display panel and a liquid crystal display device which have a high response speed.

### Solution to Problem

The present invention provides a liquid crystal display panel including a first substrate and a second substrate disposed to face each other, and a liquid crystal layer sandwiched between the first substrate and the second substrate, wherein the liquid crystal layer includes a liquid crystal molecule having positive dielectric anisotropy; the liquid crystal molecule is aligned perpendicularly to a surface of the first substrate when no voltage is applied; the first substrate includes a signal line, a scanning line, a first electrode to which an image signal is provided through the signal line, and a second electrode; the first electrode includes a first comb-tooth portion; the second electrode includes a second comb-tooth portion; the first comb-tooth portion and the second comb-tooth portion are disposed in the same layer to planarly face each other in a pixel; the second substrate includes a third electrode and a dielectric layer disposed on the liquid crystal layer side of the third electrode, the third electrode covering at least a display region; and the slowest rise response speed is not more than twice a rise response speed upon application of a maximum gradation voltage to the display panel to which no voltage has been applied.

Meanwhile, the term “aligned perpendicularly” used herein means that a pretilt angle is not necessarily exactly 90°, and the term may refer to substantially perpendicular alignment.

The display region includes a light-shielding region formed between pixels and/or in a pixel.

In the present invention, the pixel may be a picture element.

The configuration of the liquid crystal display panel of the present invention is not especially limited by other components as long as it essentially includes such components.

Preferable embodiments of the liquid crystal display panel of the present invention are mentioned in more detail below. The following embodiments may be employed in combination.

The cell gap of the liquid crystal display panel is preferably equal to or less than the length of a spacing between the first electrode and the second electrode. If the cell gap of the liquid crystal display panel exceeds the length of the spacing between the first electrode and the second electrode, the response speed may not be efficiently enhanced.

The liquid crystal display device preferably has at least two regions with different lengths of the spacings between the first electrode and the second electrode in a pixel. This arrangement can prevent occurrence of floating luminance.

The length of the spacing between the first electrode and the second electrode is preferably not more than 12 μm. If the length of the spacing between the first electrode and the second electrode is more than 12 μm, the response speed may not be efficiently enhanced.

The liquid crystal display panel may not include an over drive circuit. If no over drive circuit is included, the response speed can be efficiently enhanced.

The present invention also relates to a liquid crystal display device including the liquid crystal display panel of the present invention.

### Advantageous Effects of Invention

The liquid crystal display panel and the liquid crystal display device of the present invention can achieve a high response speed.

### BRIEF DESCRIPTION OF DRAWINGS

FIG. 1 is a planar schematic view showing a liquid crystal display device according to Embodiment 1.

FIG. 2 is an A-B line cross-sectional view of FIG. 1.

FIG. 3 is a schematic cross-sectional view showing a liquid crystal display device according to Example 1.

FIG. 4 is a schematic cross-sectional view showing a liquid crystal display device according to Comparative Example 1.

FIG. 5 shows results of measurement of response characteristics of the liquid crystal display device of Comparative Example 1.

FIG. 6 shows the response characteristics of the liquid crystal display device of Comparative Example 1 in various gradation ranges.

FIG. 7 shows results of measurement of response characteristics of the liquid crystal display device of Example 1.

FIG. 8 shows the response characteristics of the liquid crystal display device of Example 1 in various gradation ranges.

FIG. 9 shows calculation results of the transmittance of model A according to Comparative Embodiment.

FIG. 10 shows calculation results of the transmittance of model B according to Embodiment.

FIG. 11 shows calculation results of the transmittance of model C according to Embodiment.

FIG. 12 shows calculation results of the transmittance of model D according to Embodiment.

### DESCRIPTION OF EMBODIMENT

The following describes a method for measuring response characteristics used herein.

First, a pair of linear polarizers are arranged in a cross Nicol configuration with one of the polarizers provided on one side of a liquid crystal cell and the other one provided on the other side of the liquid crystal cell. The absorption axis of the one of the polarizers is arranged in an angle of 45° to the longitudinal direction of a comb-tooth portion of an electrode, and the absorption axis of the other polarizer is arranged in an angle of 135° to the longitudinal direction. Next, changes in the transmittance (brightness) are measured from the normal direction of the display surface (substrate surface) of the liquid crystal cell while changing the voltage applied to the liquid crystal cell from one voltage (initial state) to the another voltage (final state). The maximum value and the minimum value of the measured transmittance (brightness) are determined as 100% and 0%, respectively. The time period required to shift from 10% to 90% is determined as a rise response speed, τ on, and the time period required to shift from 90% to 10% is determined as a down response time, τ off. The initial state may be a state with no voltage application. The final state may be a state with no voltage application when the initial state is a voltage-applied state.

The present invention will be mentioned in more detail referring to the drawings in the following embodiments, but is not limited to these embodiments.

In the embodiments below, the 3 o'clock direction, the 12 o'clock direction, the 9 o'clock direction and the 6 o'clock direction denote respectively a 0° direction (orientation), a 90° direction (orientation), a 180° direction (orientation) and a 270° direction (orientation); while the direction running through 3 o'clock and 9 o'clock is a left-right direction and the direction running through 12 o'clock to 6 o'clock is a top-down direction, in a front view of the liquid crystal display device, i.e. in a front view of surfaces of the active matrix substrate and the counter substrate.

Further, in the drawings below, although only one picture element (subpixel) is shown, a plurality of pixels are provided in a matrix shape in a display region (region to display images) of the liquid crystal display device of each embodiment. Each pixel consists of a plurality (normally three pieces) of picture elements.

### EMBODIMENT 1

A liquid crystal display device according to the present embodiment displays image by generating an electric field in a direction oblique to a substrate surface so that the alignment of the liquid crystal molecules is controlled by the electric field.

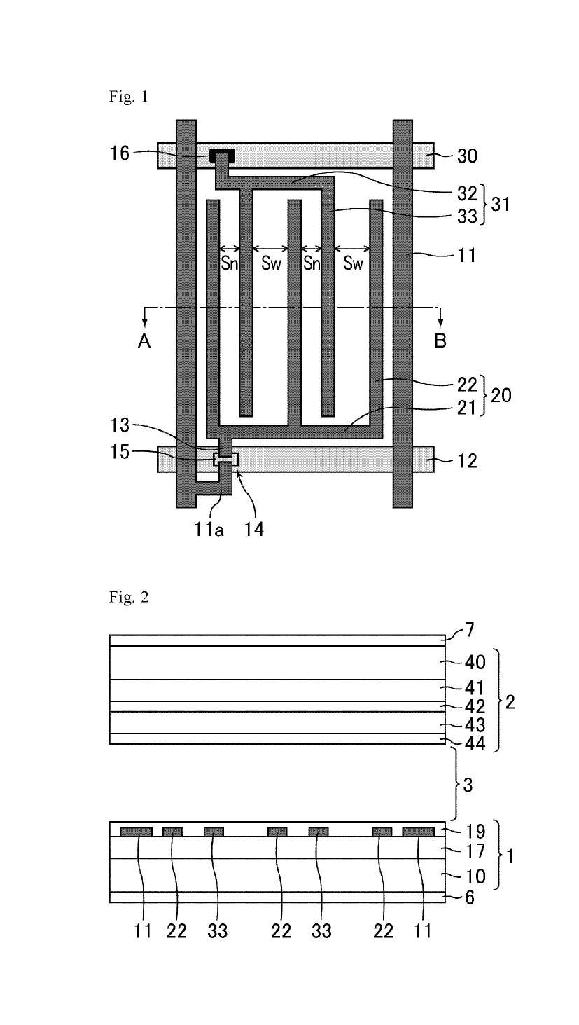

The liquid crystal display device of the present embodiment includes a liquid crystal display panel. As shown in FIG. 2, the liquid crystal display panel has a pair of substrates, i.e., an active matrix substrate (TFT array substrate) 1 and a counter substrate 2, which are disposed to face each other, and a liquid crystal layer 3 sandwiched between the substrates 1 and 2. The substrate 1 is disposed at a back side of the liquid crystal display device, and the substrate 2 is disposed at an observation side of the liquid crystal display device.

A pair of linear polarizers 6 and 7 are provided on the opposite sides to the liquid crystal layer 3 of the substrates 1 and 2, respectively. The polarizers are disposed in a cross Nicol arrangement. The absorption axis of the polarizer 6 is arranged in an angle of 45° and the absorption axis of the polarizer is arranged in an angle of 135°. An optical film such as a retardation film may be provided at least one of a position between the substrate 1 and the polarizer 6 and a position between the substrate 2 and the polarizer 7.

The substrates 1 and 2 are attached to each other with a sealing material provided in a manner to surround the display region. The substrates 1 and 2 are disposed to face each other through spacers such as plastic beads. The liquid crystal layer 3 is formed by filling a liquid crystal material as a display medium constituting an optical modulation layer in the gap between the substrates 1 and 2. Vertical alignment films 19 and 44 are provided on the surfaces on the liquid crystal layer 3 sides of the substrates 1 and 2, respectively.

The liquid crystal layer 3 includes a nematic liquid crystal material that has positive dielectric anisotropy. Liquid crystal molecules (hereinafter, also referred to simply as nematic liquid crystal) of the material exhibit a homeotropic alignment when no voltage is applied thereto (when no electric field is generated by the below-mentioned three electrodes) under the effect of an alignment regulating force of the vertical alignment films 19 and 44. Specifically, the pretilt angle of the liquid crystal layer 3 is not less than 89° (preferably not less than 89.9°). The tilt angle of less than 89° may reduce the contrast.

Thus, since the liquid crystal display panel of the present embodiment has the pair of polarizers 6 and 7 that are disposed in a cross Nicol arrangement, and the vertical-alignment type liquid crystal layer 3 as well, the liquid crystal display panel is of a normally black mode.

The vertical alignment films 19 and 44 are formed by coating of a known alignment film material such as polyimide. Although the vertical alignment films 19 and 44 are normally not subjected to a rubbing treatment, the vertical alignment films can align nematic liquid crystal in substantially a perpendicular direction relative to the film surface when no voltage is applied.

The counter substrate 2 includes a colorless transparent insulating substrate 40 formed from glass, plastic, or the like. On a main surface on the liquid crystal layer 3 side of the insulating substrate 40, a color filter layer 41 is formed, and a counter electrode 42 (corresponding to the third electrode), a dielectric layer (insulating layer) 43, and then the vertical alignment film 44 are formed thereon in the stated order.

The color filter layer 41 includes a plurality of color layers (color filters) provided corresponding to respective picture elements. The color layers are used for color image display, and are formed of a transparent organic insulating film or the like, such as an acrylic resin, that contains a pigment, and are mainly formed on picture element regions. This configuration enables color display. Each pixel is constituted by three picture elements that output colored light of R (red), G (green) and B (blue). Note that the types and number of colors of the picture elements constituting each pixel are not particularly limited, and may be set appropriately. Namely, each pixel may be constituted, for example, by picture elements of three colors such as cyan, magenta, and yellow, or may be constituted by picture elements of four or more colors.

The color filter layer 41 may further include a black matrix (BM) layer which blocks light between the picture elements. The BM layer may be formed of an opaque metal (e.g. chrome) films, an opaque organic film such as acrylic resin containing carbon, or the like. The BM layer is formed in a region corresponding to a boundary region of adjacent picture elements.

The counter electrode 42 is formed of a transparent conductive film such as an ITO film and an IZO film. The counter electrode 42, the dielectric layer 43, and the vertical alignment film 44 are formed without breaks so as to cover at least the entire display region. A predetermined potential shared by the picture elements is applied to the counter electrode 42.

The dielectric layer 43 is formed from a transparent insulating material. More specifically, the dielectric layer 42 is formed of an inorganic insulating film such as a silicon nitride film, or from an organic insulating film such as an acrylic resin film, or the like.

The dielectric constant and the thickness of the dielectric layer 43 are not particularly limited, and may be individually set appropriately.

By providing the counter electrode 42 and the dielectric layer 43 both at positions closer to the liquid crystal layer 3 than the color filter layer 41, impurities from the color filter layer 41 can be prevented from being eluted to the liquid crystal layer 3. This arrangement improves reliability. Moreover, the surface on the liquid crystal layer 3 side of the counter substrate 2 can be planarized. Thus, generation of an insensitive region in the liquid crystal layer 3 can be suppressed. Meanwhile, an insensitive region herein refers to a region hardly influenced by an electric field generated by electrodes, specifically the counter electrode 42, and below-mentioned pixel electrode 20 and common electrode 30. Furthermore, display having high contrast characteristics and little image roughness can be achieved. If irregularity exists in the boundary between the counter substrate 2 and the liquid crystal layer 3, the irregularity disturbs the electric field. Thus, the alignment of the nematic liquid crystal is disturbed, resulting in formation of unwanted domains. Moreover, if irregularity exists, the nematic liquid crystal is not perpendicularly aligned at the irregular part when no voltage is applied (during black display), and as a result, the contrast characteristic is deteriorated.

The active matrix substrate 1 includes a colorless transparent insulating substrate 10 formed from glass, plastic, or the like. As shown in FIG. 1, on a main surface on the liquid crystal layer 3 side of the insulating substrate 10, a plurality of signal lines (source bus lines) 11, a plurality of scanning lines (gate bus lines) 12, a plurality of the common wirings 30, a plurality of thin film transistors (TFTs) 14, a plurality of pixel electrodes 20 (corresponding to the first electrodes) individually provided in each picture element, and a plurality of common electrodes 31 (corresponding to the second electrode) which are individually provided in each picture elements are provided. The TFTs 14 are switching elements (active elements) and are provided individually in each picture element. A predetermined number (for example, all) of the common electrodes 31 are connected to one another via the common wirings 30. The same voltage is commonly applied to the electrodes 31.

With respect to a cross-sectional structure of the substrate 1, the scanning lines 12 and the common wirings 30 are provided on the insulating substrate 10, and a gate insulating film 17 is formed thereon. The signal lines 11, the pixel electrodes 20 and the common electrodes 31 are provided on the gate insulating film 17. The common electrodes 31 are connected to the common wiring 30 via a contact hall 16 which is formed in the gate insulating film 17. A vertical alignment film 19 is provided on the signal line 11, the common electrodes 31 and the pixel electrodes 20.

The scanning lines 12 and the common wirings 30 are formed of metal films having high melting points such as molybdenum films and tantalum films or of low resistant metal films such as aluminum films. The gate insulating film 17 is formed of a transparent inorganic insulating film such as a silicon oxide film and a silicon nitride film. The signal lines 11, the common electrodes 31, and the pixel electrodes 20 are formed of a transparent conductive film such as an ITO film and an IZO film. The signal lines 11 may be formed of metal films so as to have low resistance.

The common electrode 31 and the pixel electrode 20 are patterned by photolithography using the same film through the same process so that the electrodes are disposed on the same layer (the same insulating film). In this manner, by disposing the pixel electrode 20 and the common electrode 31 on the same or substantially the same plane, the surface on the liquid crystal layer 3 side of the substrate 1 can be substantially planarized. This arrangement can prevent the response speed from decreasing due to disturbance of the alignment of the liquid crystal molecule in the neighborhood of the common electrodes 31. Furthermore, based on the same reason as that in the case of planarizing the surface on the liquid crystal layer 3 side of the counter substrate 2, display with little image roughness and high contrast characteristics can be achieved.

The signal lines 11 are linearly disposed in parallel with one another, and extend in a top-down direction between adjacent picture elements. The width of the signal lines 11 is 1 to 10 μm (preferably 2 to 6 μm). The scanning lines 12 are linearly disposed in parallel with one another, and extend in a left-right direction between adjacent picture elements. The width of the scanning lines 12 is 1 to 10 μm (preferably 2 to 6 μm). The signal lines 11 and the scanning lines 12 are orthogonally crossed each other. Each of regions separated by the signal lines 11 and the scanning lines 12 forms an approximately single picture element region. The signal lines 11 are connected to a source driver at an outside of the display region. The scanning lines 12 are connected to a gate driver at an outside of the display region while functioning as a gate of the TFTs 14 in the display region. Moreover, pulsed scanning signals are supplied at a predetermined timing from the gate driver to the scanning lines 12. The scanning signals are applied to the TFTs 14 by a line sequential system.

The TFTs 14 are provided in the neighborhoods of intersections of the signal lines 11 and the scanning lines 12. Each of the TFTs 14 includes a semiconductor layer 15 formed in an island shape on the scanning line 12 and also includes a source electrode 11a functioning as a source and a drain electrode 13 functioning as a drain. The source electrode 11a connects the TFT 14 and the signal line 11. The drain electrode 13 connects the TFT 14 and the picture electrode 20. The drain electrode 13 and the pixel electrode 20 are formed of the same film by patterning, and thus are connected to each other.

The TFTs 14 enter an on state for only a fixed time period upon input of a scanning signal, and while the TFTs 14 are an on state, an image signal is supplied from the signal lines 11 at a predetermined timing to the pixel electrodes 20. Thereby, the image signal is written in the liquid crystal layer 3. Meanwhile, a predetermined potential that is common to the picture elements is applied to the common electrodes 31.

After being written to the liquid crystal layer 3, the image signal is retained for a fixed time period between the pixel electrode 20 to which the image signal is supplied and the common electrode 31 facing the pixel electrodes 20 and between the pixel electrode 20 and the counter electrode 42 facing the pixel electrodes 20. That is, a capacitance (liquid crystal capacitance) is formed for a fixed time period between the electrodes. In order to prevent leakage of the retained image signal, a storage capacitance may be formed in parallel with the liquid crystal capacitance. In this case, the storage capacitor line and the scanning lines 12 are formed in parallel with one another. The storage capacitance is formed between an electrode (not shown) connected to the drain electrode 13 and the storage capacitor line in each pixel. The electrode which forms the storage capacitance and the drain electrode 13 are formed of the same film by patterning, and are thus connected to each other. The common wirings 30 may be utilized as storage capacitor lines so that the storage capacitance is formed between the electrode and the common wirings 30.

Except for the time period of black display, the voltage applied to the pixel electrode 20 is different from the voltage applied to the common electrode 31 and the voltage applied to the counter electrode 42.

The pixel electrode 20 has a comb shape in a plan view and includes a linear trunk portion (pixel trunk portion 21) and a plurality of linear comb-tooth portions (pixel comb-tooth portions 22). The pixel trunk portion 21 is provided along a shorter side (lower side) of the picture element. The pixel comb-tooth portions 22 are connected to the pixel trunk portion 21, and thereby they are connected to one another. Each of the comb-tooth portions 22 extends from the pixel trunk portion 21 towards a shorter side (upper side) of the picture element that faces the pixel trunk portion 21, namely extends in an angle of substantially 90°. The pixel trunk portion 21 and the pixel comb-tooth portions 22 are formed of the same film by patterning, and thus are connected to one another.

The common electrode 31 includes a comb shape in a plan view and includes a linear trunk portion (common trunk portion 32) and a plurality of linear comb-tooth portions (common comb-tooth portions 33). The common comb-tooth portions 33 and the common trunk portion 32 are formed of the same film by patterning, and thus they are connected to one another. Namely, the common trunk portion 32 is a trunk portion (common trunk portion) of the common electrode 31, and connects the plurality of the common comb-tooth portions 33 one another. The common trunk portion 32 is connected to the common wirings 30 through a contact hole 16 formed in the gate insulating layer 17. The common wirings 30 and the common trunk portion 32 are provided in parallel with the scanning lines 12, and extend in a left-right direction between adjacent picture elements. The common comb-tooth portions 33 extend from the common trunk portion 32 towards the lower side of the picture element, namely, in a direction in an angle of substantially 270°.

Accordingly, the pixel electrode 20 and the common electrode 31 are disposed to face each other with the comb-tooth portions (pixel comb-tooth portions 22, common comb-tooth portions 33) of the respective electrodes engaging with each other. The pixel comb-tooth portions 22 and the common comb-tooth portions 33 are alternately disposed in parallel with each other with a spacing in between.

The widths (minimum widths) of the pixel comb-tooth portions 22 and the common comb-tooth portions 33 are 1 to 8 μm (preferably 2 to 6 μm). The width exceeding 8 μm reduces the aperture ratio, which may decrease the transmittance. The width of less than 1 μm may decrease the yield due to disconnection. The widths or the two comb-tooth portions may be different from each other.

In the present embodiment mentioned earlier, an oblique electric field (electric field that is oblique to the main surfaces of the substrates 1 and 2) is formed from the pixel electrode 20 towards the counter electrode 42 when a voltage is applied. Moreover, a transverse electric field (electric filed that is substantially parallel to the main surfaces of the substrates 1 and 2) is formed from the pixel electrode 20 towards the common electrode 31. The transverse electric field functions to facilitate generation of the oblique electric field. Thus, due to the presence of the transverse electric field, the oblique electric field is not so much weakened even at a position away from the pixel electrode 20. Hence, the nematic liquid crystal that has been perpendicularly aligned when no voltage is applied is aligned in parallel with the oblique electric field when a voltage is applied.

In the case where the counter electrode 42 is adjacent to the vertical alignment film 44, equipotential lines are concentrated in a neighborhood of the boundary of the counter substrate 2 and the liquid crystal layer 3. For this reason, a component in a normal direction of the oblique electric field becomes strong in the liquid crystal layer 3. As a result, the nematic liquid crystal is not laid sufficiently in some cases. In contrast, in the present embodiment, since the dielectric layer 43 is provided on the liquid crystal layer 3 side of the counter electrode 42, it is possible to prevent the equipotential lines from being concentrated in a neighborhood of the boundary of the counter substrate 2 and the liquid crystal layer 3. Thus, the component in a normal direction of the oblique electric field in the liquid crystal layer 3 can be weakened. As a result, the nematic liquid crystal can be laid sufficiently, leading to enhancement of the transmittance of the entire picture element.

The common electrode 31 and the counter electrode 42 may be grounded. A voltage of the same level and the same polarity may be applied to the common electrode 31 and the counter electrode 42. In any case, display according to the display system of the present embodiment can be achieved.

In the present embodiment, the length of the spacing between the pixel electrode 20 and the common electrode 31 is set to not more than 12 μm. The spacing between the pixel electrode 20 and the common electrode 31 herein refers to a spacing (hereinafter also referred simply to as electrode spacing S) between the pixel electrode 20 and the common electrode 31 in a lateral direction (direction perpendicular to the longitudinal direction) of the pixel comb-tooth portion 22 and the common comb-tooth portion 33. This arrangement can enhance the response speed of gradation. More specifically, the slowest rise response speed can be set to not more than twice (more preferably 1.5 times) a rise response speed upon application of a maximum gradation voltage to the display panel to which no voltage has been applied. In the case of the electrode spacing S exceeding 12 μm, the response speed may not efficiently be enhanced, possibly requiring a larger voltage to be applied. This is practically not preferable. The electrode spacing S is preferably not less than 4 μm. The electrode spacing S of less than 4 μm may deteriorate the productivity.

The liquid crystal display panel of the present embodiment as it is has excellent response characteristics. Thus, both of the liquid crystal display panel and the liquid crystal display device of the present embodiment need not to be equipped with a circuit to enhance the response characteristics, such as an overdrive circuit.

In the embodiment shown in FIG. 1, two domains with different tilt directions of the nematic liquid crystals from each other are formed in each picture element. The number of domains may be appropriately set without any particular limitation. In view of obtaining excellent viewing angle characteristics, four domains may be formed in each picture element.

The liquid crystal display device of the present embodiment includes two regions where the lengths of the electrode spacings S are different from each other in each picture element. Specifically, in each picture element, a region with a relatively narrow electrode spacing (spacing Sn region) and a region with a relatively wide electrode spacing (spacing Sw region) are formed. This arrangement allows the regions to have a different threshold of the VT characteristics from each other. Therefore, an inclination of the VT characteristics (VT curve) of the whole picture element can be smoothed, especially at low gradation. As a result, occurrence of floating luminance can be reduced, and the viewing angle characteristics can be enhanced. Meanwhile, floating luminance refers to a phenomenon that, when a relatively dark low-gradation image is displayed, and the observing direction is inclined from the front view, the image that should be seen dark appears whitish.

The length of the spacing Sn is, for example, 3 to 8 μm (preferably 4 to 8 μm). If the length of the spacing Sn exceeds 8 μm, difference with the length of the spacing Sw is small, possibly resulting in no effect of enhancing the viewing angle characteristics. If the length of the spacing Sn is less than 4 μm, a short may occur between adjacent electrodes.

The length of the spacing Sw is, for example, 6 to 12 μm, (preferably 8 to 12 μm). If the length of the spacing Sw exceeds 12 μm, the response speed may be slow. If the length of the spacing Sw is less than 6 μm, a difference with the length of the spacing Sn is small, possibly resulting in no effect of enhancing the viewing angle characteristics.

Hereinafter, formation of two or more regions respectively having electrode spacings S of different lengths from one another in each picture element (pixel) is also referred to as formation of multi-space.

Furthermore, in the present embodiment, the cell gap d is preferably smaller than the length of the electrode spacing S. This arrangement can further enhance the response speed of gradation. The cell gap d is preferably smaller than the length of all the electrode spacings S (for example, spacing Sn and spacing Sw).

Meanwhile, the numbers of the pixel comb-tooth portions 22 and the common comb-tooth portions 33 are not particularly limited and each may be appropriately set as long as the numbers allow the two kinds of comb-tooth portions to be alternately disposed in each picture element.

In the present embodiment, the number of the regions where the lengths of the electrode spacings S are different from one another in a single picture element is not particularly limited, and may be not less than three. Even if the number is not less than three, in the same manner as the case of two, occurrence of floating luminance can be reduced, and the viewing angle characteristics can be enhanced.

### EMBODIMENT 2

A liquid crystal display device of the present embodiment is different from the liquid crystal display device of Embodiment 1 on the following points.

In the present embodiment, no multi-space is formed, and the number of the electrode spacing S is limited to one. As a result, fast response characteristics can be obtained even in the case where pixels are small, and thus the electrode spacings hardly have different lengths from one another.

The present embodiment in which no multi-space is formed preferably has a smaller cell gap d than the length of the electrode spacing S. This arrangement can further enhance the response speed of gradation.

The liquid crystal panel of the present embodiment itself has excellent response characteristics. Thus, both of the liquid crystal display panel and the liquid crystal display device of the present embodiment need not to be equipped with a circuit such as an overdrive circuit to enhance the response characteristics.

### EXAMPLE 1

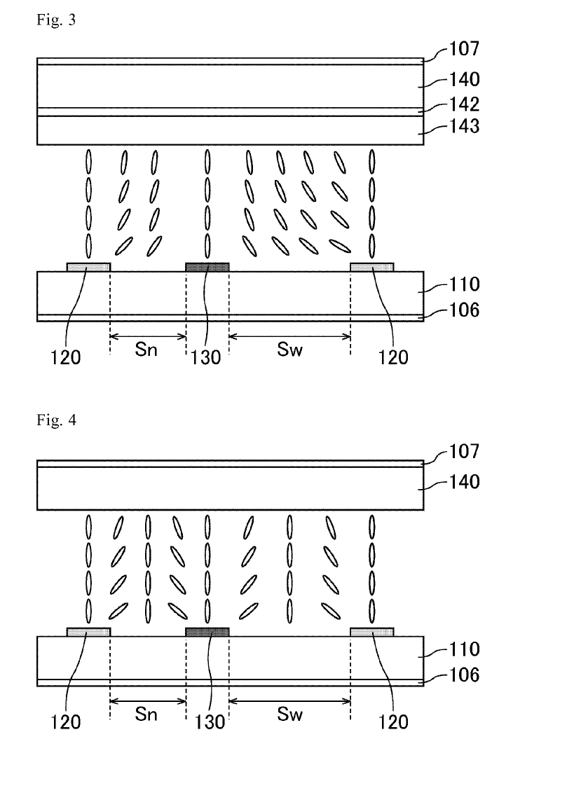

The following will explain a method for producing a liquid crystal display panel of Example 1 shown in FIG. 3.

First, scanning lines and common wirings were formed by patterning on a glass substrate 110, and a gate insulating film and a semiconductor layer were formed thereon in the stated order. Next, the gate insulating film and the semiconductor layer were patterned. Subsequently, signal lines, a source electrode, and a drain electrode were formed. At the same time, a pixel electrode 120 (pixel trunk portion and pixel comb-tooth portion) and a common electrode 130 (common trunk portion and common comb-tooth portion) were patterned. The common trunk portion was connected to the common wirings through a contact hole provided in the gate insulating film. In this manner, the electrodes 120 and 130 were formed on the same layer. The widths of the pixel comb-tooth portion and the common comb-tooth portion were 2.5 μm. In this Example, a multi-space including two electrode spacings Sn and Sw was formed. Specifically, the lengths of the spacings Sn and Sw were 7 μm and 10 μm, respectively. Next, an alignment film material including polyimide was applied to the electrodes 120 and 130, and signal lines to form a vertical alignment film. Accordingly, an active matrix substrate of Example 1 was produced.

Next, the following will discuss a method for producing a counter substrate of Example 1.

First, a color filter layer, a counter electrode 142, and a dielectric layer 143 were formed in the stated order on a glass substrate 140. The dielectric layer 143 was formed of an acrylic resin, and had a dielectric constant of 3.5 and a thickness of 1.5 μm. Thereafter, an alignment film material including polyimide was applied to the dielectric layer 143 to form a vertical alignment film.

After attachment of the above two substrates to each other with a sealing material, a nematic liquid crystal material having positive dielectric anisotropy was injected into a gap between the substrates. The cell gap d was adjusted to 3.5 μm. The dielectric constant Δε was 22.

Lastly, polarizers 106 and 107 were respectively attached to the external sides of the substrates. The polarizers 106 and 107 were disposed in a cross Nicol arrangement.

### COMPARATIVE EXAMPLE 1

FIG. 4 shows a schematic cross-sectional view of the liquid crystal display panel according to Comparative Example 1.

A liquid crystal display panel of Comparative Example 1 was produced in the same manner as Example 1, except that the counter electrode 142 and the dielectric layer 143 were not formed in the counter substrate in the present Comparative Example.

FIG. 5 shows results of measurement of response characteristics (rise response speed τ on, down response speed τ off, and total τ of the τ on and the τ off) of the liquid crystal display panel of Comparative Example 1. FIG. 5 also shows the response speed between the minimum gradation and the middle gradation or the maximum gradation. Namely, in FIG. 5, each plot shows a result of measurement of the response speed between the gradation of the plot and the minimum gradation. As shown in FIG. 5, Comparative Example 1 included a middle gradation range where the τ on was extremely slow. Moreover, two peaks of the τ on were present. This is considered due to formation of a plurality of electrode spacings S. Observation of the panel found a dark line between the electrodes 120 and 130. Moreover, observation under application of various voltages found that it took time to stabilize the alignment condition of the liquid crystal at the rise of the panel. For this reason, the response speed was slow.

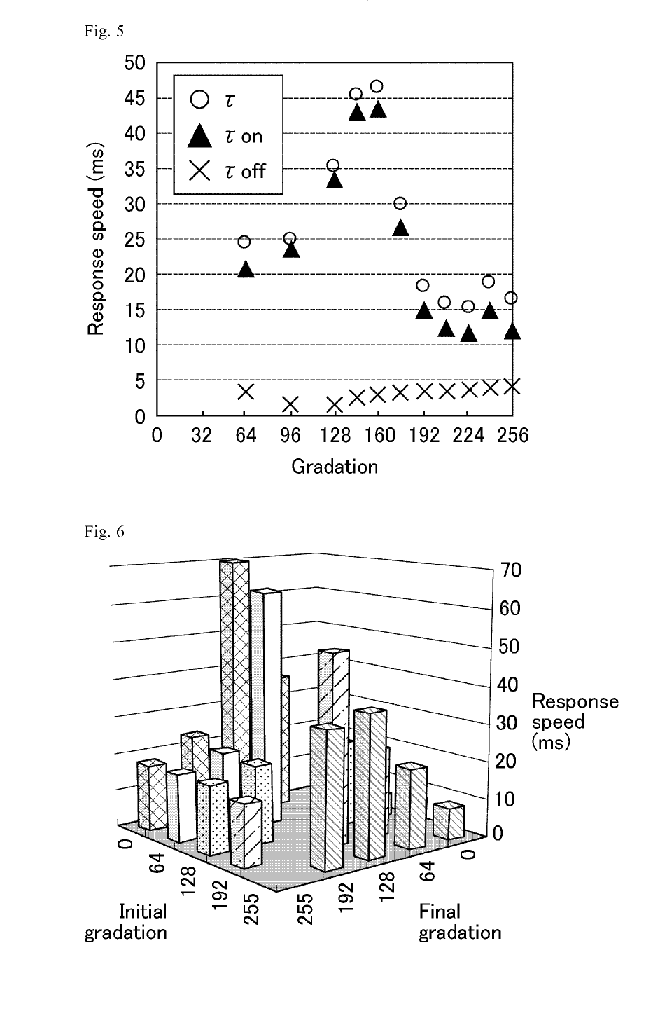

FIG. 6 and Table 1 show the response characteristics of the liquid crystal display panel of Comparative Example 1 among various gradations. In comparative Example 1, the slowest τ on (τ on, max) of 70 ms was observed in a change from the minimum gradation (0 gradation) to 128 gradation level. Moreover, the τ on (τ on, B to W) from the minimum gradation (0 gradation) to the maximum gradation (255 gradation) was 17.7 ms. Therefore, the τ on, max is 3.95 times as high as the τ on, B to W, which means that the rise response speed to the middle gradation is significantly deteriorated in Comparative Example 1.

TABLE 1

| | | Final gradation | | | | |
|---|---|---|---|---|---|---|
| | | 0 | 64 | 128 | 192 | 255 |
| Initial | 0 | | 36.5 | 70 | 23.6 | 17.7 |
| gradation | 64 | 5.2 | | 62.9 | 21.6 | 17.9 |
| | 128 | 5.7 | 22.8 | | 20.8 | 18.1 |
| | 192 | 7.3 | 23.3 | 50.3 | | 16.3 |
| | 255 | 8.2 | 20.9 | 37.3 | 34.9 | |

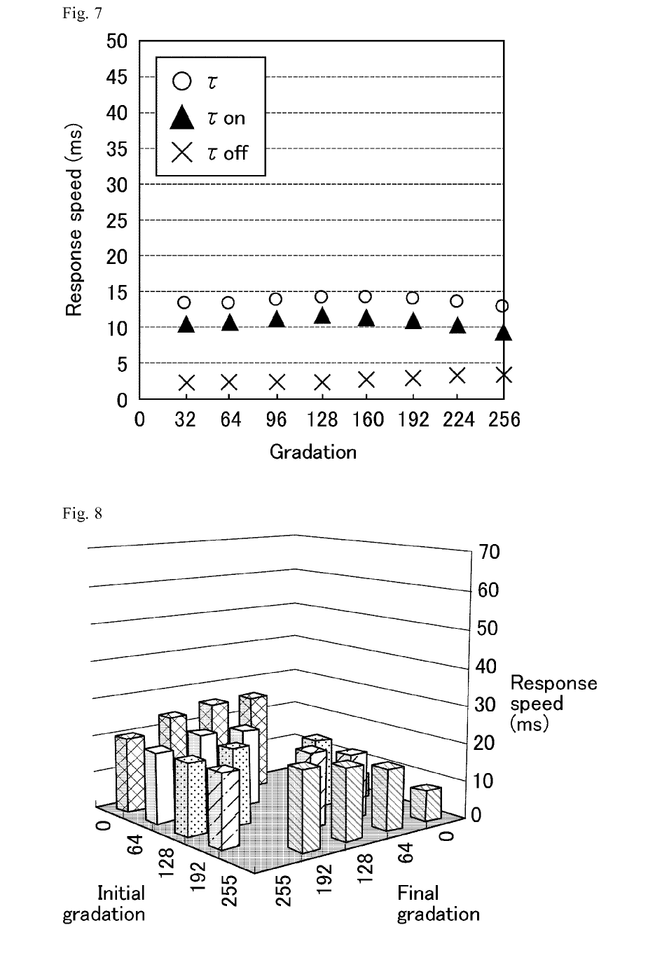

FIG. 7 shows results of measurement of the response characteristics (τ on, τ off, and τ) of the liquid crystal display panel of Example 1. FIG. 7 shows the response speed between the minimum gradation and the middle gradation or the maximum gradation. Namely, in FIG. 7, each plot shows a result of measurement of the response speed between the gradation of the plot and the minimum gradation. As shown in FIG. 7, in Example 1, the τ on was not slow in a middle gradation range. The response speed was extremely high in all the gradations. Unlike Comparative Example 1, microscopic observation of the panel found no dark line. Accordingly, in terms of enhancing the response characteristics, it is found to be important to avoid formation of a dark line.

FIG. 8 and Table 2 show the response characteristics of the liquid crystal display panel of Example 1 among various gradations. In Example 1, τ on, max of 25.8 ms occurred during the change from the minimum gradation (0 gradation) to 64 gradation. The τ on, B to W was 20.2 ms. Therefore, the τ on, max is 1.28 times as high as the τ on, B to W. It is thus found that the rise response speed to the middle gradation is significantly high in Example 1.

TABLE 2

| | | Final gradation | | | | |
|---|---|---|---|---|---|---|
| | | 0 | 64 | 128 | 192 | 255 |
| Initial | 0 | | 25.8 | 25.7 | 24 | 20.2 |
| gradation | 64 | 6.1 | | 20.6 | 21.6 | 19.1 |
| | 128 | 6.5 | 18.4 | | 20.6 | 19.2 |
| | 192 | 7.3 | 17.1 | 20 | | 19.6 |
| | 255 | 8.1 | 16.2 | 19 | 20.9 | |

An explanation follows below on simulation results of the transmittance while variously changing the pattern of the electrode. As a simulator, an LCD master (product of Shintec. Inc.) was used.

The common simulation conditions are as follows:
Width of the pixel electrode (comb-tooth portion): 4 μm
Width of the common electrode (comb-tooth portion): 4 μm
Voltage of the pixel electrode: DC (direct current) voltage is applied.
Voltage of the common electrode: DC (direct current) voltage of 0 V is applied.
Voltage of the counter electrode: DC (direct current) voltage of 0 V is applied.
Δε: 22

FIG. 9 shows calculation results of the transmittance of model A according to the comparative embodiment, obtained in the case where voltages of 1 to 6 V were applied to the pixel electrode. In the model A, the cell gap d was set to 3.5 μm, and the electrode spacing S was set to 4 μm. Moreover, no counter electrode and dielectric layer were provided on the counter substrate of the model A. As a result, a dark line appeared between the pixel electrode and the common electrode.

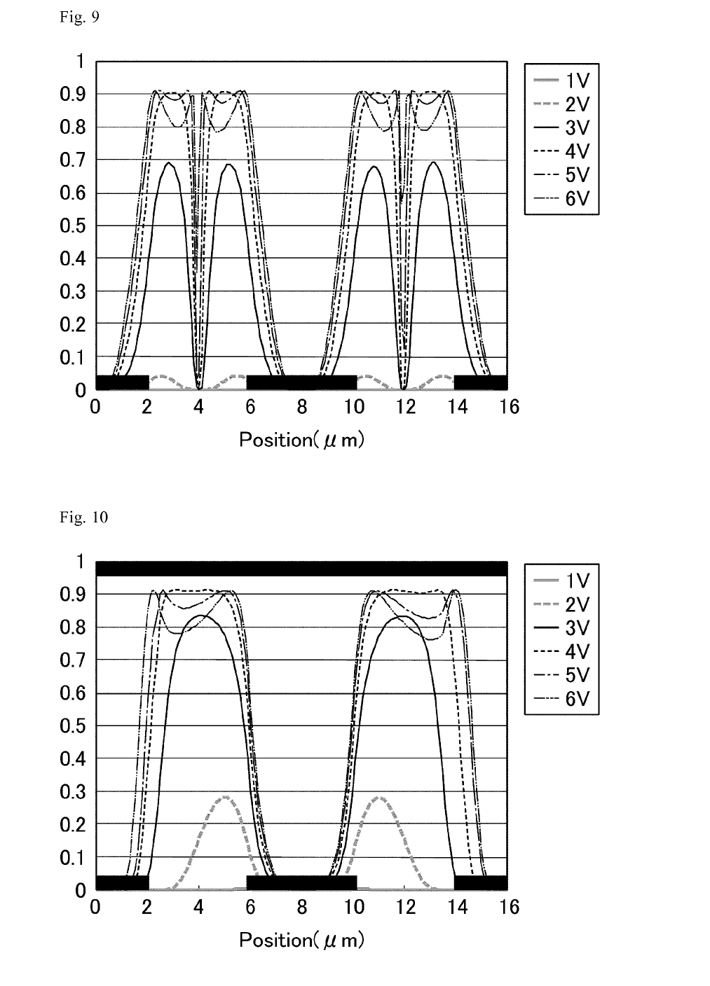

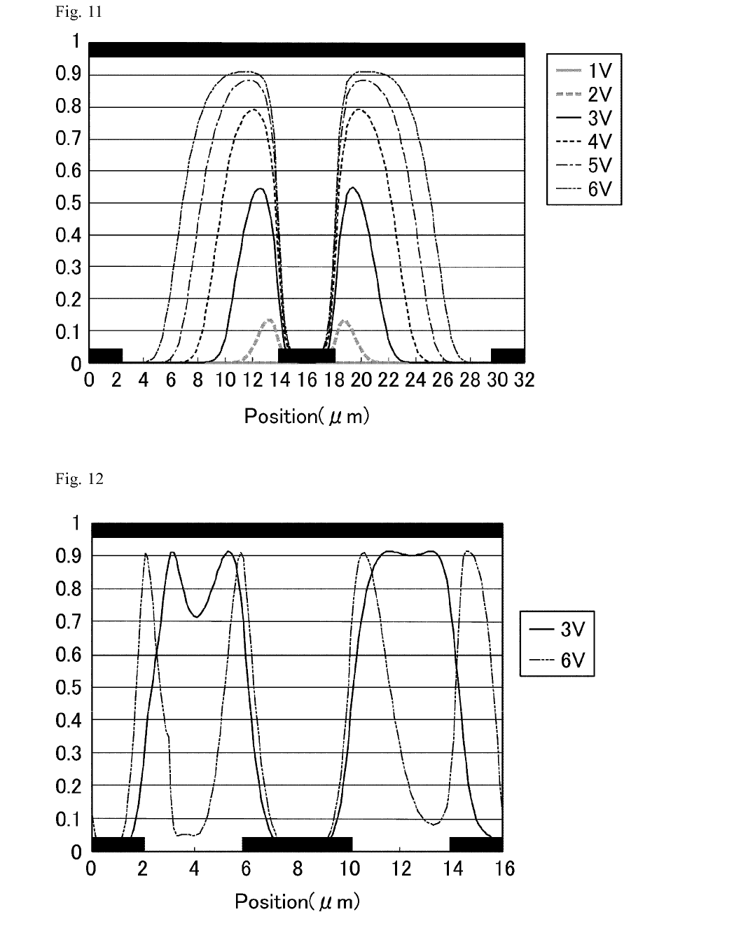

FIGS. 10 to 12 each show calculation results of the transmittance of models (models B to D) according to the embodiments. The results shown in FIG. 10 and FIG. 11 were obtained in the case where voltages of 1 to 6 V were applied to the pixel electrode. The result shown in FIG. 12 was obtained in the case where voltages of 3V and 6V were applied to the pixel electrode. A counter electrode and a dielectric layer were provided on the counter electrode of each of the models B to D. The dielectric layer was disposed at the liquid crystal layer side of the counter electrode, with the dielectric constant and the thickness thereof set to 3.5 and 1.5 μm, respectively.

In the model B, the cell gap d was set to 3.5 μm, and the electrode spacing S was set to 4 μm. As shown in FIG. 10, a dark line did not appear between the pixel electrode and the common electrode in the model B.

In the model C, the cell gap d was set to 3.5 and the electrode spacing S was set to 12 μm. As shown in FIG. 11, a dark line did not appear between the pixel electrode and the common electrode in the model C.

In the model D, the cell gap d was set to 9 μm, and the electrode spacing S was set to 4 μm. As shown in FIG. 12, a dark line appeared between the pixel electrode and the common electrode in the model D. This is considered because, in the case where the cell gap d is larger than the length of the electrode spacing S, the transverse electric field generated between the pixel electrode and the comb-tooth portion of the common electrode effectively (dominantly) affects the liquid crystal layer. Therefore, the response speed is assumed to be slowed at a voltage that forms a dark line in the model D. In terms of enhancing the response speed, it is found to be important to set the cell gap d to be smaller than the electrode spacing S.

The present application claims priority to Patent Application No. 2010-6688 filed in Japan on Jan. 15, 2010 under the Paris Convention and provisions of national law in a designated State, the entire contents of which are hereby incorporated by reference.

### REFERENCE SIGNS LIST

1: Active matrix substrate
2: Counter substrate
3: Liquid crystal layer
6, 7: Polarizer
10, 40: Insulating substrate
11: Signal line
11a: Source electrode
12: Scanning line
13: Drain electrode
14: TFT
15: Semiconductor layer
16: Contact hole
17: Gate insulating film
19, 44: Vertical alignment film
20: Pixel electrode
21: Pixel trunk portion
22: Pixel comb-tooth portion
30: Common wiring
31: Common electrode
32: Common trunk portion
33: Common comb-tooth portion
41: Color filter layer
42: Counter electrode
43: Dielectric layer

1. A liquid crystal display panel comprising
a first substrate and a second substrate disposed to face each other, and
a liquid crystal layer sandwiched between the first substrate and the second substrate, wherein
the liquid crystal layer includes a liquid crystal molecule having positive dielectric an isotropy;
the liquid crystal molecule is aligned perpendicularly to a surface of the first substrate when no voltage is applied;
the first substrate includes a signal line, a scanning line, a first electrode to which an image signal is provided through the signal line, and a second electrode;
the first electrode includes a first comb-tooth portion;
the second electrode includes a second comb-tooth portion;
the first comb-tooth portion and the second comb-tooth portion are disposed in the same layer to planarly face each other in a pixel;
the second substrate includes a third electrode and a dielectric layer disposed on the liquid crystal layer side of the third electrode, the third electrode covering at least a display region; and
the slowest rise response speed is not more than twice a rise response speed upon application of a maximum gradation voltage to the display panel to which no voltage has been applied.

2. The liquid crystal display panel according to claim 1, having a cell gap equal to or less than a length of a spacing between the first electrode and the second electrode.

3. The liquid crystal display panel according to claim 1, wherein
the liquid crystal display panel includes at least two regions with different lengths of spacings between the first electrode and the second electrode in a pixel.

4. The liquid crystal display panel according to claim 1, wherein a length of a spacing between the first electrode and the second electrode is not more than 12 μm.

5. The liquid crystal display panel according to claim 1, comprising no over drive circuit.

6. A liquid crystal display device comprising the liquid crystal display panel according to claim 1.
